(19) United States
(12) Patent Application Publication
(10) Pub. No.: US 2009/0313185 A1
(43) Pub. Date: Dec. 17, 2009

(54) Method of marketing a product

(76) Inventor: James H. Johnson, JR., Lexington, KY (US)

Correspondence Address: KING & SCHICKLI, PLLC, 247 NORTH BROADWAY, LEXINGTON, KY, 40507, US

(21) Appl. No.: 11/996,689

(22) PCT Filed: Jul. 25, 2006
(86) PCT No.: PCT/US06/28865

§ 371 Date: Jan. 24, 2008

Related U.S. Application Data
(60) Provisional application No. 60/702,476, filed on Jul. 26, 2005.
(60) Provisional application No. 60/781,799, filed on Mar. 13, 2006.
(60) Provisional application No. 60/771,371, filed on Feb. 8, 2006.

(51) Int. Cl. G06Q 90/00

(52) U.S. Cl. 705/500

(57) ABSTRACT

A marketing method includes the steps of acquiring site placement rights from retailers of a product at different locations, providing staging structures for the product at those different locations and promoting sales of the product by transmitting promotional information about the product over a radio frequency at the different locations.

This application claims the benefit of U.S. provisional patent applications, Ser. Nos. 60/702,476 filed 26 Jul. 2005, 60/771,371 filed 8 Feb. 2006 and 60/781,799 filed 13 Mar. 2006.

### TECHNICAL FIELD

The present invention relates generally to the marketing of a product by establishing a radio network for the product.

### BACKGROUND OF THE INVENTION

Many product vendors including particularly but not exclusively limited to dairy and beverage vendors must provide just-in-time delivery services to their high demand retail customers. Typically those retail customers require daily or every other day delivery of products such as milk, beer, soft drinks and sport drinks. It is a significant management challenge to design and develop an efficient delivery schedule to meet retailer demand. Further, transportation costs have recently spiked due to increases in gasoline prices. Unfortunately, expectations are for gasoline and diesel fuel prices to continue to rise. As a result delivery costs will trend higher.

The present invention relates to a method for staging product wherein transportation and manpower costs may be reduced dramatically by staging inventory on site at retailer locations. Such an approach also simplifies the development and coordination of delivery schedules.

### SUMMARY OF THE INVENTION

In accordance with the purposes of the present invention as described herein, a method of marketing a product with a radio network comprises the steps of acquiring site placement rights from retailers of the product at different locations, providing staging structures for the product at those different locations and promoting sales of the product by transmitting promotional information about the product over a radio frequency at those different locations. The method further includes placing a supply of the product in the staging structures and marketing advertising on a side of those staging structures.

The method also includes restocking the retailers with product taken or transferred from the product staging structure. Still further, the method may include equipping the structures with electronic display devices and even remotely establishing programming for display by the electronic display devices. Still further, the method may include issuing an Amber Alert emergency message over the electronic display devices as a public service.

In the following description there are shown and described preferred embodiments of this invention, simply by way of illustration of two of the modes best suited to carry out the invention. As it will be realized the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWING

The accompanying drawing incorporated in and forming a part of this specification, illustrates several aspects of the present invention and together with the description serves to explain certain principles of the invention. In the drawing:

FIG. 1 is a perspective view of a beer staging structure provided adjacent a retail location that sells the beer; and

FIG. 2 is a schematical cross-sectional view of the storage structure of FIG. 1 showing the conveyor floor.

### DETAILED DESCRIPTION OF THE INVENTION

As noted above, the present business method relates to product staging. That method may be generally and broadly described as including the steps of acquiring a site placement right for a product staging structure from a retailer, placing the product staging structure at the site adjacent the retailer and marketing space in the product staging structure to a vendor of a particular product sold by the retailer. The method may also include storing the particular product of the vendor in the product staging structure for eventual sale by the retailer. For purposes of interpretation of this document, the term “vendor” includes a wholesaler, distributor, manufacturer or any entity having an interest in selling or marketing a particular product. Still further, the method may also include the step of marketing advertising space on the product staging structure. In addition the method may include the step of sharing revenue generated by marketing advertising space on the product staging structure with the retailer or vendor.

Alternatively, the method of the present invention may be described as comprising the steps of placing a product staging structure at a site adjacent a retailer and marketing space in the product staging structure to a vendor of a particular product sold by the retailer. This method may further include the step of marketing advertising space on the product staging structure and even the step of sharing with the retailer or vendor revenue generated by marketing advertising space on the product staging structure.

In yet another alternative, the method may comprise the steps of contracting with a vendor to stage and promote a product marketed by the vendor and placing a product staging structure adjacent a retailer of the product. Still further, the method may comprise the steps of contracting with a vendor to stage and promote a brand of beverage, placing a product staging structure adjacent a retailer of that brand of beverage and collecting revenue from said vendor for staging and promoting that brand of beverage. The beverage may include but is not limited to soft drinks, sports drinks and beer.

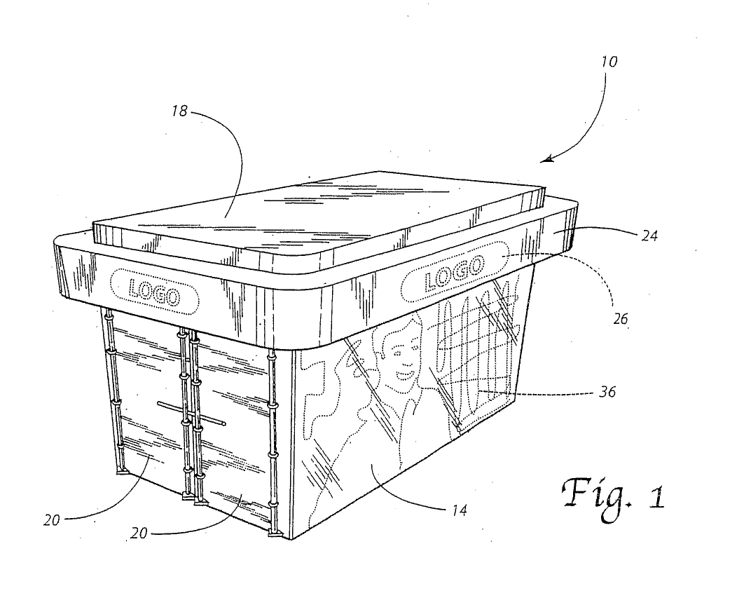

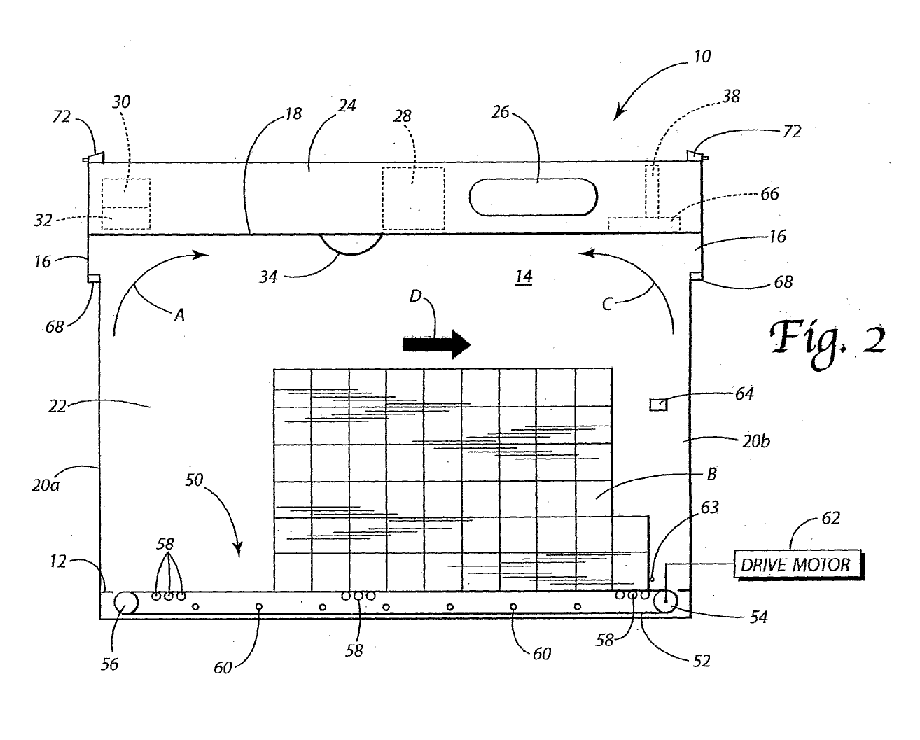

One possible construction of a storage/staging structure a/k/a integrated advertising and storage structure or outbuilding 10 is illustrated in FIGS. 1-2. More specifically the storage structure 10 includes a floor 12, two side walls 14, an end wall 16 and a roof 18. A pair of cooperating, locking doors 20 define a second end wall opposite the first end wall 16. Any type of door 20 useful for the intended purpose may be utilized. Together, the floor 12, side walls 14, end walls 16, roof 18 and doors 20 define an interior storage space 22. That storage space 22 may be customized to meet the vendor's needs including particular rack, shelving, partitioning layouts as required or desired by the vendor for purposes of inventory storage and control. The interior customization may, of course, be tailored to integrate with inventory control technology such as bar coding.

Similarly, the exterior of the storage structure 10 may be customized to match the trade dress and/or architectural features of the retailer's main building near which the storage structure 10 may be placed into service. Thus, for example, the storage structure 10 may include a decorative roof cap 24 sized and shaped to customer specifications. The roof cap 24 may include customer advertising, trade dress or logo 26 if desired and/or as allowed by local regulations.

The storage structure 10 may also be equipped with various electrical and/or mechanical systems. For example, a climate control unit such as an air conditioner, refrigerator, freezer, humidifier or dehumidifier 28 may be provided on the storage structure 10 in order to provide climate control of the storage space 22 within the storage structure. Accordingly, products such as perishable food, dairy products, soft drinks and beer may be maintained at the desired temperatures even in hot and humid environments.

In addition, the storage structure 10 may be equipped with a solar panel 30 and cooperating battery 32 to store energy for powering an internal lighting system 34 for illuminating the storage space 22 or illuminating advertising 36 on the side wall 14, end wall 16 or other exterior component of the storage structure 10. That advertising 36 may comprise a stretched banner material and it may be front lit or back lit as desired. If desired, power for all the electrical and mechanical components of the storage structure 10 may be provided through an electrical circuit box carried on the housing 10 and connected to the lines of the local electric utility supplier. Alternatively, the housing 10 may carry an electric generator. In one possible embodiment, the generator may be driven by natural gas and connected to the underground supply line of the local natural gas provider. In another possible embodiment, the generator may be driven by propane and the structure may further include a propane storage tank for supplying propane to the generator. Of course, that propane storage tank could also be provided underground. In yet another alternative, the electric generator is powered by a fuel cell.

Still further, the storage structure 10 may incorporate a radio transmitter 38 for the transmission of short range advertisements respecting products displayed in the advertising 36 appearing on the exterior surface of the storage structure 10. A particularly effective advertising combination is the use of a backlit digital graphic advertising banner 36 in conjunction with local transmission radio advertising providing details of the particular product. This is particularly effective when advertising a product that is sold at the customer's place of business.

The storage structure 10 may be constructed from any appropriate material. The storage structure 10 could be constructed in the manner of a standard trailer or box truck and may or may not include additional architectural details. The storage structure 10 may be constructed, for example, from modular building materials such as prefabricated panels 40 of the type shown and described in, for example, U.S. Pat. Nos. 6,279,287 to Meadows, 5,373,678 to Hesser and 6,119,427 to Wyman et al. Such modular panels typically incorporate a core of thermal insulating material sandwiched between metal or plastic sheathing. Such a construction provides both efficient and effective control of the temperature and humidity of the environment in the internal storage space 22 and excellent inclement weather durability for a long, low-maintenance service life.

Structures 10 constructed from such modular building panels 40 are also characterized by high strength and will resist high winds and maintain a weather-tight enclosure to protect products held in the storage space 22 from inclement weather. In fact, such structures may be easily anchored to the ground such as by means of cooperating nut and bolt anchors where the bolt is held in an underlying poured concrete pad. The modular panels 40 also allow the storage structure 10 to be quickly and easily erected and subsequently removed in a minimal amount of time while producing a minimum of mess.

An electronic display device such as a message board or video display device 36 may be mounted on the surface of the side wall 14, end wall 16 or door 20 or recessed in a cavity in such a wall. A transparent, shatterproof shield 39 may be provided over the device 36 to protect it from vandalism. The video display device 36 may take substantially any appropriate form including but not limited to a liquid crystal display or a plasma monitor. The device 36 may also include one or more speakers 41 for the presentation of audio. Thus, audio/video advertising is possible. In this way, TV-like advertising is brought out of the home to a potential customer at or near a point of sale where it can be most effective.

Reference is now made to FIG. 2 illustrating an alternative embodiment and various control features that may be incorporated into the structure 10.

As illustrated in the FIG. 2 embodiment, the structure 10 incorporates a first access or inventory stocking door 20a and a second or retailer access door 20b. As illustrated the two access doors 20a, 20b are provided at opposite ends 16 of the structure 10. After positioning the structure 10 at the desired site adjacent a retail store, the beer supplier opens the inventory stocking door 20a (note action arrow A) and fills the structure 10 with beer B. After filling the structure the stocking door 20a is closed and locked.

The retailer opens the retailer access door 20b (note action arrow C) and removes beer B from the structure 10 to stock the shelves at the adjacent retail location. Following removal the retailer access door 20b is also closed and locked.

As illustrated in FIG. 2, the structure 10 is equipped with a conveyor floor generally designated by reference numeral 50. As illustrated the conveyor floor 50 includes a conveyor belt 52, a drive roller 54, an idler roller 56, a series of support rollers 58, a series of return rollers 60 and a drive motor 62. When the beer supplier returns to the structure 10 to restock the structure with beer, the conveyor floor 50 is activated to advance any remaining beer inventory in the direction of action arrow D from the inventory stocking door 20a toward the retailer access door 20b. An electric eye or other proximity sensor 63 can be provided to automatically defeat operation of the conveyor floor 50 when the beer approaches the end wall 16 by the retailer access door 20b. The supplier then opens the inventory stocking door 20a and fills the structure 10 with a new supply of beer. This method insures that inventory is used on a first-in and first-out basis.

The structure 10 may also be equipped with an inventory monitoring system. That inventory monitoring system may take any number of forms including, for example, a bar code scanner 64 provided adjacent the retailer access door 20b. When the retailer 20b removes beer from the structure 10 the retailer runs the beer past the bar code scanner 64 which sends a signal to a controller 66. The controller 66 can then send a signal via hard wire, wireless internet connection or other means to the beer supplier so as to notify the beer supplier that the retailer is removing beer from the structure 10. By monitoring beer removals the beer supplier knows when to return to the structure 10 to restock the beer.

It should also be noted that the structure 10 may be equipped with an alarm system. The alarm system may include sensors 68 to detect the jimmying of any lock or the unauthorized opening of any door 20a, 20b. The sensor 68 may be connected to the controller 66 which automatically contacts the beer supplier and/or local law enforcement in the event of a break-in. Once again, it should be appreciated that the contact may be made by hard wire, wireless internet connection, telephone connection or any other appropriate means. Of course, if desired, the structure 10 may also include one or more security cameras 72.

The present method of marketing a product with a radio network includes the steps of acquiring site placement rights from various retailers of the product at different locations, providing staging structures for the product at the different locations and promoting sales of the product by transmitting promotional information about the product over a radio frequency at the different locations. The radio transmitters may be provided on the staging structure if desired. The method also includes the steps of placing a supply of the product in the staging structures, advertising on the side of the staging structures, equipping the structures with electronic display devices and even establishing programming for the electronic display devices from a remote location. In addition, the method may include issuing an “Amber Alert” emergency message over the electronic display devices.

The foregoing description of a preferred embodiment of the present invention has been presented for purposes of illustration and description. It is not intended to be exhaustive or to limit the invention to the precise form disclosed. Obvious modifications or variations are possible in light of the above teachings. For example, the structure 10 could be equipped with a rotary sign assembly of the type described in U.S. Pat. No. 4,021,946. Such a device includes a series of three sided elements allowing one to periodically display three different advertisements. Further, the conveyor floor 50 could be formed by a series of aligned rollers allowing one to simply push product across the floor over the rollers.

The embodiments were chosen and described to provide the best illustrations of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims and their fair and broad interpretation in any way.

What is claimed:

1. A method of marketing a product with a radio network, comprising:
acquiring site placement rights from retailers of said product at different locations;
providing staging structures for said product at said different locations; and
promoting sales of said product by transmitting promotional information about said product over a radio frequency at said different locations.

2. The method of claim 1 including placing a supply of said product in said staging structures.

3. The method of claim 2, including restocking said retailers with said product by taking said product from said product staging structures.

4. The method of claim 1, including marketing advertising on a side of said staging structures.

5. The method of claim 1, including equipping said structures with electronic display devices.

6. The method of claim 5, including remotely establishing programming for display by said electronic display devices.

7. The method of claim 6, including issuing an Amber Alert emergency message over said electronic display devices.

8. The method of claim 1, including providing radio transmitters on the staging structures.
